(19) United States
(12) Patent Application Publication
(10) Pub. No.: US 2019/0383930 A1
(43) Pub. Date: Dec. 19, 2019

(54) METHOD AND DEVICE FOR RADAR DETERMINATION OF THE COORDINATES AND SPEED OF OBJECTS

(71) Applicant: LIMITED LIABILITY COMPANY "INNOVATIVE CENTER JEWEL", Voronezh (RU)

(72) Inventors: Nikolay Andreevich SAMOTSVET, Voronezh (RU); Vladimir Pavlovich LIHACHEV, Voronezh (RU); Sergei Nikolaevich PANYCHEV, Voronezh (RU); Leonid Borisovich RYAZANTSEV, Voronezh (RU); Dmitry Andreevich SAMOTCVET, Voronezh (RU)

(73) Assignee: LIMITED LIABILITY COMPANY "INNOVATIVE CENTER JEWEL", Voronezh (RU)

(21) Appl. No.: 16/478,871

(22) PCT Filed: Apr. 18, 2017
(86) PCT No.: PCT/RU2017/000245

§ 371 Date: Jul. 18, 2019

(51) Int. Cl. G01S 13/58; G01S 13/42; G01S 13/50; G01S 7/03

(52) U.S. Cl. CPC G01S 13/58; G01S 7/03; G01S 13/505; G01S 13/42

(57) ABSTRACT

The invention relates to the field of radiolocation and can be used in on-board radar stations for determining the coordinates and speed of moving and stationary objects with a high accuracy. The technical result which can be achieved is an increase in the accuracy of determining the coordinates and velocity of objects and targets having a low level of effective reflective area. The essence of the method consists in assessing the rate of change in frequency of the additional linear frequency modulation (LFM) of a signal reflected from an object and dependent on the movement of the latter, with subsequent calculation of the distance to the object taking into account the value of an initial frequency of the received LFM signal. Said technical result is achieved by the fact that the distance to the object is determined on the basis of a change in the frequency of a probing LFM signal, taking into account Doppler corrections. The method is realized with the aid of a device comprising the following, interconnected in a defined manner: M channels for emitting a continuous LFM signal at various frequencies and polarizations, N channels for receiving echo signals, an N-channel parameter assessment device, an N-channel device for generating supporting functions, a received-signal multiplier with supporting functions, a rapid Fourier transformation unit, a device for searching for the maximum of a mutual correlation function, and a sensor of the intrinsic speed of a radar-station carrier.

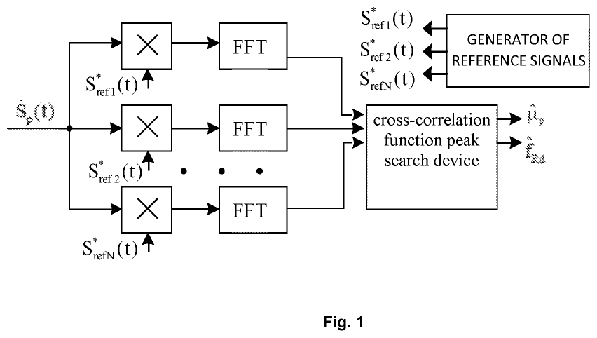

### FIELD OF THE INVENTION

The invention relates to the field of radiolocation and can be used in on-board radars for determining the coordinates and speed of moving and stationary objects with high accuracy.

### BACKGROUND OF THE INVENTION

There is known a method of parallel circular radar surveillance of space, implemented in radar RIAS-four-coordinate radar (determines range, azimuth, elevation angle and radial velocity: D. Thibaud, J. P. Eglizeaud. 4D tracking processor for synthetic pulse and antenna radar (RIAS), RADAR-89, 1989, p. 370-374) operating in the meter range of waves. Circular transmitting and receiving antenna arrays are used in RIAS, arranged concentrically. This method is characterized by an accelerated space view (simultaneous survey without forming a scanning beam), radiation and reception are omnidirectional. The characteristic of generation of the emitted sum signal is the omnidirectional emission of coherent partial signals at different frequencies by spatially spaced antenna elements (emitters). Hereinafter, an elementary antenna (radiator) is an elementary antenna (vibrator, slit antenna and the like), which can operate both on the radiation and the reception, and which is included as a composite element in the transmitting or receiving antenna of the Radar. Thus, RIAS allows encoding of the irradiated space: the signals emitted in each direction have the properties of the individual code. The target rereflects the signal with the same code, which is a feature of the zone in which it is. Here, the target location is determined by a simple receiver system (RIAS, RADAR A IMPULSION ET ANTENNE SYNTHETIQUE/J. Dorey, G. Gamier, G. Auvray//International Conference on Radar.—Paris., 1989 Apr. 24-28.—P. 556-562; Le radar qui de″tecte les avions “invisibles”/M. Chabreuil//L″Usine Nouvelle Technologies, 1989, v. 64, mai, p. 64-68). In this method, encoding involves the use of orthogonal codes of the emitted signal (eg, using signals at different frequencies) as necessary, in particular for uniform irradiation of the controlled space (RIAS, RADAR A IMPULSION ET ANTENNE SYNTHETIQUE/J. Dorey, G. Garier H L″Onde Electrique, November-December 1989, V. 69, N 6, P. 36-44). The reception feature is digital signal processing and digital beam forming in implicit form. The position of each target is determined by taking into account the delays of orthogonal (partial) the components of the probing signal from each individual radiator of the transmitting antenna to the target and from the target to each separate element of the receiving antenna. At the same time spatial compression of the radiated signal and the temporal compression of the set of radiated partial signals are realized. The digital processing involves coherent processing of the signal which implements, in particular, the conversion of discrete frequencies of the received partial signals; the filtering functions, the purpose of which is selection of targets by doppler frequency, range, azimuth and angle. Continuous or quasi-continuous radiation makes it possible to increase the resolution in range and speed.

The disadvantage of this method is the dependence of the accuracy of determining the coordinates of the target from the size of the antenna.

Large dimensions of horizontal aperture are due to method of processing received signals. The onboard radars have limitations on the dimensions and weight of the antennas, so that the method does not make it possible to provide the required accuracy of the determination of the target coordinates. The disadvantage of this method is also the complexity of digital processing requiring the execution of a large number of computational operations.

A method of radar detection of target coordinates is also known in the simultaneous circular view of space (Patent Application FR 2709835 A1, G 01 S 13/52), which consists in simultaneous omnidirectional or locally spaced spatially spaced radiation of coherent signals at the same frequency (in the prototype there is provided an embodiment of the method, when the signal is emitted in a narrow wavelength range, see FR 2709835 A1, C. 6), simultaneous, omnidirectional or locally directed, spatially spaced reception of signals reflected from the targets, selection of received signals by speed and range, joint processing of signals selected by speed and range with subsequent separation from interference. Combined processing of signals selected by speed and range consists in formation of radiation patterns and elimination of false signals, received side lobes, using statistical processing. This method assumes the emission of separate signals with such characteristics that upon reception they have been identified.

The disadvantage of this method is the necessity of using antennas with a large horizontal aperture, with the limitations on the dimensions of the antenna the accuracy of determination of the target coordinates is not high.

The closest to the claimed invention is the method of radar determination of the coordinates of the targets (RF patent 2127437).

The essence of the method consists in simultaneous omnidirectional or locally directed radiation (individual emitters) M first coherent signals at the same frequency; simultaneously, omnidirectional or locally directed coherent reception of N first signals reflected from target signals and their selection by speed and range and subsequent separate summation over each of range-rate channels with storage of summation results; additional radiation with time diversity with respect To M first transmitted coherent signals, simultaneously, omni-directional or locally directed (individual emitters) at the same frequency as the M first coherent signals, M second coherent signals with reciprocal phase shift, simultaneous, omnidirectional or locally directed coherent reception of N second reflected signals with phase shifts, corresponding phase shifts of the emitted m second coherent signals; selection of N second received signals by speed and range; summing N second frequency-sampled and range signals separately for each of range-rate channels; determining phase differences of signals summed over distance-rate channels and corresponding to N first received signals, and signals summed over distance-Rate channels and corresponding to N second received signals; at that phase differences of signals are determined for respective range-speed channels corresponding to each other; signals selected by speed and range are separated from interferences. Thus, after the above actions are performed, each of the interference-derived signals is mapped to a range (range channel), speed (Doppler filter number) and azimuth (phase difference value).

In general, the number of elements of the receive and transmit antennas may be different, i.e. M is not equal to N, therefore, the phase shifts of the signals of the individual radiators for forming and receiving the rotating field are generally different. It is assumed that coherent accumulation of the received rotating field signals can be produced prior to measuring the phase differences and before the separation of signals from the interferences and coherent accumulation of received synphase field signals in several reception and transmission cycles. Taking into account the coherence of the radiation and reception of the signals of the rotating field and the signals of the in-phase field, said coherent accumulation may be carried out by radiation of “nested” burst bursts of in-phase and rotating fields. The separation of the signals from the interferences can be made after measuring the phase differences of the received signals of the in-phase and rotating fields, or after separation of signals from interferences, measurement of phase differences is performed only for those ranging-speed channels, in which the target signal is detected, the measured phases of the received signals of the in-phase and rotating fields must be pre-stored. In order not to lose the payload information, the separation of the signals from the interferences is expediently carried out after the summation of the received signals of the in-phase and rotating fields in the same ranging-speed channels.

The disadvantage of the prototype method is non-high accuracy of determination of coordinates and speed of target with low level of effective scattering surface against background of local objects or interferences, both natural and artificially created.

### SUMMARY OF THE INVENTION

Technical result of claimed technical solution consists in improvement of accuracy of determination of coordinates and speed of objects and targets with low level of effective area of dispersion.

The claimed technical result is achieved as follows:

In the claimed technical solution is to estimate the rate of change of frequency of the additional linear frequency modulated (LFM) signal reflected from object caused by their movement, followed by calculating the distance to the object by the value of the initial frequency of the received Modulated waveform.

The method of radar determination of coordinates and speed of objects comprises the following stages:
probe radar objects and targets in the upper, lower hemispheres or in the rear access to the space relative to the radar carrier platform using M-channel partial and polarization radar;
receive and demodulate signals reflected from stationary local objects and from moving targets with the help of an N-channel receiver;
direction finding of the azimuth and elevation angle of radar objects by the methods of: direction finding based on directional patterns, Direction finding by aperture sampling or monopulse direction finding;
calculate a joint estimate of the additional (secondary) linear frequency modulation's parameters \hat{μ}ₚ and \hat{f}_{Rd} of the demodulated signal; calculate the object radial velocity: \hat{V}ᵣ=\hat{μ}ₚC/(4μ)
calculate the Doppler frequency: \hat{f}_{d}=2f₀\hat{V}ᵣ/c
obtain information about an own radar carrier speed, calculating a corresponding Doppler frequency \hat{f}_{d0} and calculate a range frequency: \hat{f}_{R}=\hat{f}_{Rd}−\hat{f}_{d}−\hat{f}_{d0}.
calculate distance to the object: \hat{R}₀=\hat{f}_{R}c/2μ).

The radar device for determining coordinates and speed of objects, has M channels of radiation of continuous linear frequency modulated signal at different frequencies and polarizations and N channels of reception of the echo signals at different frequencies and polarizations, characterized in that an N-channel \hat{μ}ₚ and [symbol] -parameters estimator is added to the receiving device, contains an N-channel device for generating reference functions (signals), the outputs of which are connected to the inputs of multipliers of a received signal with reference functions, the outputs of which are connected to the inputs of fast Fourier transform units, the outputs of which are connected to the cross-correlation function peak search device, the input of the cross-correlation function peak search device is connected to the output of the radar carrier's own velocity sensor.

### BRIEF DESCRIPTION OF THE DRAWINGS

The FIGURE illustrates the operation of the unit estimator for range and radial velocity of an object.

### DETAILED DESCRIPTION OF INVENTION

The claimed technical solution works as follows.

The procedure for obtaining estimates of azimuth A, elevation angle B, range \hat{R}₀, and radial velocity \hat{V}ᵣ of a target consists in the sequential execution of the following operations.

Probing radar objects and targets in the upper, lower hemisphere, or in a given sector of space relative to the carrier radar with a continuous linear frequency modulated signal using an M-channel in frequency and polarization radar. The emitted radar signal of a single amplitude in each period of sounding duration T_{M} is a linear frequency-modulated (LFM) oscillation, by the expression (1).

$${\dot{S}}_{tr} ( t ) = exp \{ j 2 π ( {f}_{0} t + μ \frac{{t}^{2}}{2} ) + j {ψ}_{0} \} \qquad ( 1 )$$

t∈[0, T_{M}]; f₀—initial frequency, μ=ΔF/T_{M}—rate of change of frequency, ψ₀—initial phase of linear frequency modulated signal; ΔF—probe signal width; T_{M}—modulation period of the probing signal.

Receiving and demodulation of signals reflected from stationary local objects and moving objects by means of an N-channel receiver. The movement of the object and the movement of the radar carrier causes the difference frequency to appear in the demodulated signal of an additional (secondary) linear frequency modulation. The demodulated signal at the output of the receiving device is described by the expression

$${\dot{S}}_{p} ( {t}_{M} ) = {A}_{t} exp ( j 2 π ( {f}_{Rd} {t}_{M} + \frac{{μ}_{p}}{2} {t}_{M}^{2} ) ) , \qquad ( 2 )$$

Aₜ—target (object) echo amplitude; f_{Rd}=_{R}+f_{d}+f_{d0}; f_{R}=2μR₀/c—range frequency, f_{d}=2Vᵣ/λ—Doppler frequency of radar object; f_{d0}—Doppler frequency corresponding to the radar carrier's own speed at the current radiation frequency; μₚ=4 μVᵣ/c—slope (rate of change of frequency) of additional (secondary) linear frequency modulation; Vᵣ— radial target (object) speed; R₀— distance to the object; c—light speed; λ=c/f₀, f₀—initial frequency.

Direction finding of the azimuth and elevation angle of radar objects by the methods of: direction finding based on directional patterns, Direction finding by aperture sampling or monopulse direction finding.

Calculation a joint estimate of the additional (secondary) linear frequency modulation's parameters \hat{μ}ₚ and \hat{f}_{Rd} of the demodulated signal, by the expression (2).

Calculation a radial velocity of the object, in accordance with (3)

\hat{V}ᵣ=μₚc/(4μ). (3)

Calculation a Doppler frequency in accordance with (4)

\hat{f}_{d}=2f₀\hat{V}ᵣ/c. (4)

Obtaining information about an own radar carrier speed, calculating a Doppler frequency corresponding to the radar carrier's own speed \hat{f}_{d0} and calculating a range frequency \hat{f}_{R}

\hat{f}_{R}=\hat{f}_{Rd}−\hat{f}_{d}−f_{d0}. (5)

Calculating distance to the object: in accordance with (6)

\hat{R}₀=\hat{f}_{R}c/(2μ). (6)

The calculation of the joint estimate of non-energy echo parameters \hat{μ}ₚ and \hat{f}_{Rd} can be performed using a maximum likelihood estimation [Grishin Yu. P., Ipatov V P, Kazarinov Yu. M. Radio systems/ed. Yu. M. Kazarinov. M.: Higher School, 1992. 496 p]. In this case, the parameter estimates correspond to the position of maximum two-dimensional correlation function for different values f ℏ μ_{ref}.

\dot{S}(f,μ_{ref})=F{\dot{S}ₚ(t)S_{ref}*(t,μ_{ref})}, (7)

\dot{S}_{ref}(t,μ_{ref})=exp{jπμ_{ref}t²}, (8)

f—frequency; F—the Fourier transform operator; μ_{ref}∈[μ_{p min}, μ_{p max}]; μ_{p min} and μ_{p max}—the boundaries of the prior interval of parameter values μₚ, defined by the minimum and maximum radial speeds of targets in accordance with expression (3).

$$\begin{matrix}{\hat{μ}}_{p} = {arg max}_{f} ( \vert \dot{S} ( f , {μ}_{ref} ) \vert ) , & ( 9 ) \\ {\hat{f}}_{Rd} = {arg max}_{{μ}_{ref}} ( \vert \dot{S} ( f , {μ}_{ref} ) \vert ) . & ( 10 )\end{matrix}$$

It should be noted that setting the value of μ_{p min} is greater than a certain threshold, it is possible to realize a selection of moving targets relative to local objects.

The new proposed method of radar for determining coordinates and velocity of the moving target as compared with prototype operation are 5-9, which makes it possible to increase accuracy in determining the distance to the object and their radial velocity.

The claimed technical result is also achieved in, device for processing signals reflected from the objects additionally uses a parameter estimation unit for calculating a radial velocity and range and Radar speed sensor own vehicle.

A block diagram of a device for the parameters \hat{μ}ₚ and \hat{f}_{Rd} are shown in the FIGURE.

It contains N channels (according to the number of reference functions), which calculates N correlations of the current state of the signal \dot{S}ₚ(t) with all the reference functions generated by the reference functions (signals) generation unit, followed by finding the spectrum by performing the Fast Fourier Transform (FFT) operation.

The number of channels in the system N is chosen from the condition of the required accuracy Δμ_{p need} of approximation of the function (7) by the parameter μ_{ref} and the range [μ_{p min}, μ_{p max}], i.e. N=|μ_{p max}−μ_{p min}/Δμ_{p need}.

The cross-correlation function peak search device searches the function \dot{S}(f, μ_{ref}) maximum, then calculating the estimates of the parameters \hat{μ}ₚ and \hat{f}_{Rd}.

If the signal \dot{S}ₚ(t) of the signals of several targets function (7) has several maxima, the position of which are determined by the parameters of movement of each of the targets.

The proposed method of radar determination of the coordinates and speed of a mobile target and a device for its implementation allow coherent accumulation of echo signals during a separate sensing period under conditions when the change in distance from the target during the sensing period exceeds the resolution of the radar in range.

They also make it possible to implement the selection of moving targets on the background reflections from further analysis due to the linear frequency modulated signal due to movement of the target. Our theoretical and experimental investigations show output accuracy estimates can be used to determine the radial velocity and range of targets. It has been found that the standard deviation (SD) velocity estimate decreases in proportion to an increase in the spectrum width and the modulation period of the probing signal and the SD of the range estimate is proportional to the square of the probing signal spectrum width.

The claimed technical solution is industrially applicable, because for its realization are industrially manufactured and commercially useful resources.

Although the claimed technical solution is described in a particular example embodiment, this description is not intended to be limiting, but is merely for illustration and better understanding of the technical solution, the scope of which is defined by the appended claims.

1-2. (canceled)

3: A method for determination of coordinates and speed of an object with a radar, comprising the following stages:
(a) probing stationary objects and moving objects with the radar in an upper or lower hemisphere, or in a given sector of a space relative to a carrier of the radar by emitting a continuous linear frequency-modulated probing signal using an M-channel in frequency and polarization of the radar, wherein T_{M} is a modulation period of the probing signal;
(b) receiving signals reflected from the stationary objects and moving objects using an N-channel receiver and demodulating them;
(c) direction finding of an azimuth and elevation angle of at least one of the stationary objects or moving objects probed by the radar by the methods of: direction finding based on directional patterns, direction finding by aperture sampling or monopulse direction finding;
(d) calculating a joint estimate of an additional secondary linear frequency modulation's parameters \hat{μ}ₚ and \hat{f}_{Rd} of the demodulated signal, using a received echo of the emitted radar signal reflected from the object, wherein \hat{μ}ₚ is a rate of change of frequency of the additional secondary linear frequency modulation that arises due to a movement of the object and the radar carrier and is proportional to a relative radial velocity of the object; and \hat{f}_{Rd} is an frequency of the additional linear frequency modulation that is a sum of frequencies f_{Rd}=f_{R}+f_{d}+f_{d0}, wherein f_{R}—range frequency, f_{d}—Doppler frequency of the object, f_{d0}—is a Doppler frequency corresponding to the radar carrier's own speed at the current radiation frequency;
(e) calculating a radial velocity of the object: \hat{V}ᵣ=μₚc/(4μ), wherein μ=ΔF/T_{M} is a rate of change of frequency, ΔF is a probe signal width, c is the light speed;
(f) calculating a Doppler frequency: \hat{f}_{d}=2f₀\hat{V}ᵣ/c, wherein f₀ is an initial frequency of the signal emission;
(g) obtaining information about an own radar carrier speed and calculating a range frequency \hat{f}_{R}=\hat{f}_{Rd}−\hat{f}_{d}−\hat{f}_{d0};
(h) calculating a distance to the object: \hat{R}₀=\hat{f}_{R}c/(2μ).

4: A radar device for determining coordinates and speed of an object, the device comprises: M channels for radiation of a continuous linear frequency-modulated signal at different frequencies and polarizations, and a receiving device that contains N channels for receiving echo signals at different frequencies and polarizations;
wherein the receiving device further comprises an N-channel \hat{μ}ₚ and \hat{f}_{Rd}-parameters estimator that contains an N-channel device for generating reference functions, and the outputs of said N-channel device are connected to the inputs of multipliers of a received signal with reference functions;
wherein the outputs of said multipliers are connected to the inputs of fast Fourier transform units; wherein the outputs of said fast Fourier transform units are connected to a cross-correlation function peak search device;
and wherein the input of the cross-correlation function peak search device is connected to the output of a radar carrier's velocity sensor.
